(19) United States
(12) Patent Application Publication
(10) Pub. No.: US 2015/0299516 A1
(43) Pub. Date: Oct. 22, 2015

(54) COATING COMPOSITION

(71) Applicant: PROGEL PTY LTD, Brisbane, Queensland (AU)

(72) Inventor: Lai Tran, Carina Heights, Queensland (AU)

(73) Assignee: ProGel Pty Ltd, Brisbane (AU)

(21) Appl. No.: 14/647,340

(22) PCT Filed: Nov. 26, 2013
(86) PCT No.: PCT/AU2013/001363

§ 371 Date: May 26, 2015

(30) Foreign Application Priority Data
Nov. 26, 2012 (AU) 2012905167

(51) Int. Cl. C09D 189/00; C09D 105/00

(52) U.S. Cl. CPC C09D 189/00; C09D 105/00

(57) ABSTRACT

The present invention relates to a coating composition comprising a blend of a denatured protein, a lipid, a polyol plasticizer, trehalose, and a carrier. The invention further relates to methods of producing coating compositions, and products coated with the coating compositions. The invention further relates to use of a coating composition to mask, or reduce or prevent development of, flavours. Also, the present invention relates to use of a coating composition to prevent or reduce degradation of an active in a coated product, or to prevent or reduce leakage of an active from a coated product. Certain embodiments of the present invention relate to coating compositions that are suitable for coating microparticles. Some embodiments of the present invention relate to use of a coating composition to maintain probiotic viability or to improve probiotic survival in a product containing a probiotic.

### TECHNICAL FIELD

The present invention relates to coating compositions, methods of producing coating compositions, and products coated with coating compositions. The invention further relates to use of a coating composition to mask, or reduce or prevent development of, flavours. Also, the present invention relates to use of a coating composition to prevent or reduce degradation of an active in a coated product, or to prevent or reduce leakage of an active from a coated product. Certain embodiments of the present invention relate to coating compositions that are suitable for coating microparticles. Some embodiments of the present invention relate to use of a coating composition to maintain probiotic viability or to improve probiotic survival in a product containing a probiotic.

### BACKGROUND

Microencapsulation is a process in which thin films or coatings or solid/gel matrix surround, enclose and/or immobilise tiny particles or droplets that could be of any state of matter (solids, liquids or gases). The resultant microparticles are typically spherical in shape and contain active material or core material surrounded by continuous wall or trapped in the solid or gel matrix.

The aim of microencapsulation is to provide a substance (active) in a finely divided state. It is desirable to preserve the encapsulated active from degradation by limiting its exposure to the external environment (e.g. heat, moisture, acid, air, light) and to release it at a controlled rate under specific conditions on demand. Furthermore, it is desirable to render volatile, sensitive, and reactive compounds stable through encapsulation by providing a microparticle with suitable barrier properties. In addition, when the active is a substance to be ingested by a human or animal, it may be desirable to mask any flavour of the active, particularly when the flavour may be perceived by the consumer as being objectionable.

In certain applications, the material used to encapsulate the active can provide the active with suitable levels of protection from degradation, stability and flavour masking. However, often the encapsulation material is porous. Thus, the encapsulated active may nevertheless be exposed to a degrading exterior environment. Also, the active itself may leak out of the microparticle, thus exposing it to a degrading environment, and any flavour associated with the active may emanate from the microparticle and be perceived by the person or animal ingesting it. An opportunity therefore remains to address or ameliorate one or more shortcomings or disadvantages associated with existing microencapsulation methods and/or to at least provide a useful alternative thereto.

### SUMMARY OF THE INVENTION

The present invention provides a coating composition comprising a blend of a lipid, a polyol plasticizer, trehalose, a denatured protein and a carrier. The present invention further provides a coating composition formed by blending together a lipid, a polyol plasticizer, trehalose, a denatured protein and a carrier.

The present invention further provides a process for producing a coating composition comprising blending together a lipid, a polyol plasticizer, trehalose, a denatured protein and a carrier.

Also, the present invention provides a coating formed from a coating composition according to the present invention.

The coating composition provided by the present invention may be particularly suited to coating microparticles intended to be ingested by humans or animals, but it is not limited thereto. The mechanical and barrier properties of the coating of the present invention may be useful for coating microparticles generally. Thus, there is provided a coated product comprising a microparticle coated with the coating composition of the present invention. Furthermore, the coating composition may be used to coat other products, including other products that may be ingested, such as tablets of pharmaceutical or nutritional (nutraceutical) formulations.

The present invention further provides a method of masking flavours comprising coating an active having a flavour with a coating composition according to the present invention. The invention also provides a method of preventing or reducing development of a flavour comprising coating an active capable of developing a flavour upon exposure to a degrading environment with a coating composition according to the present invention to prevent or to reduce exposure of the active to the degrading environment.

A method of preventing or reducing degradation of an active is also provided, said method comprising coating an active with a coating composition according to the present invention to prevent or to reduce exposure of the active to a degrading environment.

Furthermore, a method of preventing or reducing leakage of an active from a product is provided, said method comprising coating a product containing an active with a coating composition according to the present invention to prevent or to reduce leakage of the active from the product.

These and other aspects of the invention, including use of the inventive composition to mask, or to prevent or to reduce the development of, flavours; to prevent or to reduce degradation of an active; and to prevent or to reduce leakage of an active from a product; are described in more detail below. In some embodiments, the present invention provides a method of maintaining probiotic viability or improving probiotic survival in a product containing a probiotic, said method comprising coating the product with the coating composition of the present invention. The use of the coating composition of the present invention to maintain viability or to improve survival of a probiotic in a product is also provided.

### DETAILED DESCRIPTION

The coating composition of the present invention comprises a blend of a lipid, a polyol plasticizer, trehalose, a denatured protein and a carrier. That is, these components (e.g. a lipid, a polyol plasticizer, trehalose, a denatured protein and carrier) are starting materials or ingredients which, when suitably combined, interact and bond to produce the coating composition of the present invention. As will be discussed in further detail below, a number of synergistic interactions occur between the components of the coating composition in order to provide a coating with desirable barrier and mechanical properties. These interactions may take advantage of the hydrophilic and hydrophobic character of the denatured protein to form beneficial hydrogen and hydrophobic bonds, and the ability of trehalose to stabilise the protein and the lipid.

The present invention particularly relates to a coating for products, such as microparticles, that are intended to be ingested by humans, but potentially other animals. Accordingly, it will be appreciated by the skilled person that the ingredients of the coating composition of the present invention are selected such that they are fit for purpose. That is, in the case of a coating composition intended to be ingested by humans the ingredients of the coating composition are approved for human consumption by any necessary authorities. Likewise, for products intended for animal consumption, the ingredients will be approved for such use. By way of example, the present invention is generally described with reference to products intended for human consumption.

In general, components that are fit for human consumption may be considered edible or food-grade. That is, the components are intended to be consumed and they are not merely in a nontoxic form which is ancillary to their ultimate and intended purpose.

The coating may be used in pharmaceutical or nutritional formulations (e.g. nutraceuticals), dietary supplements, functional foods and beverage products. For example, food and beverages for humans as well as animals (e.g. pet food) may be supplemented (fortified) using microparticles, containing one or more desirable actives, that are coated using the composition of the present invention. Suitable examples of beverage products include, but are not limited to, water; milk; milk alternatives including, but not limited to, soy, rice, oat and almond “milks”; water-based beverages; milk-based beverages; carbonated beverages; non-carbonated beverages; beer; wine; and fruit and/or vegetable-based beverages.

Suitable fruit and/or vegetable-based beverages may include one or more fruit extracts and/or vegetable extracts. An extract includes juice, nectar, puree and/or pulp of or from the relevant fruit or vegetable. The extract may be fresh, raw, processed (e.g. pasteurized) or reconstituted. The one or more fruit extracts may be selected from, but are not limited to, the group comprising apple juice, pineapple juice, one or more citrus fruit juices (i.e. one or more juices of orange, mandarin, grapefruit, lemon, tangelo, cumquat, etc.), cranberry juice, noni juice, acai juice, goji juice, blueberry juice, blackberry juice, raspberry juice, pomegranate juice, grape juice, apricot juice or nectar, peach juice or nectar, pear juice, mango juice, passionfruit juice and guava puree. The one or more vegetable extracts may be selected from, but are not limited to, the group comprising aloe vera juice, beet juice, carrot juice, celery juice, kale juice, spinach juice, tomato juice and wheat grass juice. Furthermore, vegetable extracts may include extracts of herbs or spices, such as ginger juice.

The coating provided by the composition may mask flavours and/or prevent flavours from developing. “Flavour” as used herein includes tastes or smells that may be perceived by the human or animal ingesting the coated product. This flavour may be perceived by a consumer as being an objectionable flavour. An “objectionable flavour” as used herein includes tastes or smells that may be perceived by a consumer of the coated product as being unpleasant or “off”. These flavours may be astringent, bitter, musty, chalky, reminiscent of cardboard, fishy, sulfurous (i.e. a smell or taste associated with decomposing protein), metallic, rusty and/or generally foreign. Flavours may be inherent to one or more components of the coating itself and/or of the product that is coated. Alternatively or additionally, flavours may result from one or more components of the coating itself and/or of the product that is coated partially or fully degrading.

In some embodiments, the active may not have a flavour that is, of itself, considered objectionable. However, it may nevertheless be desirable to mask the flavour of this active as it may detract from the quality of a product that the coated product may be incorporated into. For example, when the coated product is a coated microparticle, it may be incorporated into dietary supplements, functional foods and beverage products and in these goods it may be desirable for the flavour of the active not to taint the flavour of the good. As an example, if the coated microparticles are incorporated into orange juice to provide a supplemented juice, it may be desirable to mask the flavour of the active so that the consumer does not perceive any change in the flavour of the juice as a result of the supplementation (fortification).

The coating composition of the present invention has four key ingredients: a lipid, a polyol plasticizer, trehalose and a denatured protein, in a carrier. The carrier is a solvent for at least the trehalose. In addition, at least a portion of the carrier is suitable for forming a denatured protein mixture with the protein. A coating is formed by applying the composition to an object or product, such as a microparticle, and evaporating carrier. Suitable carriers include water, ethanol or ethanol-water mixtures. Typically, the carrier for the present invention will be water.

As used herein, the term “protein” refers to proteins having residues which are capable of undergoing thiol-disulfide interchange reactions and/or thiol oxidation reactions. In their natural states, proteins generally exist as either fibrous proteins or globular proteins. Fibrous proteins are water insoluble and serve as the main structural materials of animal tissues. Globular proteins are soluble in water or aqueous solutions of acids, bases or salts and feature widely in living systems. Fibrous proteins are typically fully extended and associated closely with each other in parallel structures, generally through hydrogen bonding, to form fibres. Globular proteins fold into complicated spherical structures held together by a combination of hydrogen, ionic, hydrophobic and covalent (disulfide) bonds. The chemical and physical properties of these proteins depend on the relative amounts of component amino acid residues and their placement along the protein polymer chain.

The protein may be a protein derived from nature or a synthetic polypeptide. In some embodiments, the protein may be a modified protein. For example, the protein may be one in which serine residues have been converted into cysteine residues using enzymic conversion.

The protein used in the coating of the present invention is preferably a globular protein. In embodiments where the protein is a fibrous protein, the fibrous protein is typically modified so that it becomes water soluble. For example, where the fibrous protein is collagen it may be modified by hydrolysis to convert it into gelatine.

Preferred globular proteins for use in the present invention are those which are isolated from milk, wheat, soy, egg, mung bean, pea, rice and corn. Proteins derived from milk include whey proteins and caseins. In certain embodiments, whey protein is the preferred protein for the coating. Whey proteins are the proteins that remain soluble after caseins are precipitated at pH 4.6. Whey proteins, which are globular and heat labile in nature, consist of several component proteins, including α-Lactalbumin, β-Lactoglobulin, bovine serum albumin, immunoglobulins, and proteosepeptones.

In some embodiments, it may be desirable to select a protein from a plant source. For example, it may be desired to provide a coating that may be consumed by vegans.

In some embodiments, a protein with low allergenic properties may be selected for use in the coating. For example, a pea or rice protein may be used as less people have allergic responses to these proteins in comparison to milk and soy proteins or wheat gluten. In addition, pea protein may be more readily digested than some other proteins.

The protein may be provided in the form of a protein concentrate or a protein isolate. A “protein concentrate” is a protein-rich product prepared by treating a protein source in an ultra-filtration process which removes liquid and smaller molecules. Often the ultra-filtration process used for preparing protein concentrates is a diafiltration process. Industrially produced protein concentrates, such as whey protein concentrate, may have a protein content of 25 to 80%.

The term “protein isolate” as used herein refers to a product resulting from the extraction, subsequent concentration, and purification of proteinaceous material from a proteinaceous source. Protein isolates can be prepared by treating protein concentrates using, for example, an ion exchange process. Isolates may have protein contents in the order of 90%. In certain embodiments, the protein is a whey protein isolate.

The protein is typically provided in a solution or dispersion in a solvent. The solvent will often be the carrier, but it may be a component of the carrier when a mixture of liquids is used as the carrier. After application of the coating composition to the product, the solvent/carrier evaporates leaving the ultimate coating. Suitable solvents/carriers include water, ethanol or ethanol-water mixtures. Water is often the preferred solvent/carrier. The protein may constitute about 5 to about 15% of the solution or dispersion by weight, preferably about 8 to about 12% by weight, more preferably about 10% by weight. Typically, the protein is denatured in the carrier in a ratio that will be used throughout the coating. That is, the total amount of carrier in the coating often comes from the dispersion or solution of the denatured protein in the carrier. Although, in some embodiments a portion of the carrier may be added at a later stage together with, or after, one or more of the other components is blended with the denatured protein. The quantities of other components of the coating composition are typically determined on a weight basis in terms of the denatured protein and the total amount of carrier. For simplicity, the combination of the denatured protein and total amount of carrier are referred to herein as the denatured protein mixture even though in some embodiments a portion of the carrier may be added when, or after, one or more of the other components is blended with the denatured protein.

The denaturation process disrupts the quaternary, tertiary and secondary structures of the protein. The protein will be denatured in the presence of a solvent or the carrier so that the denatured protein can adopt a more extended structure as it is denatured. An extended protein conformation is advantageous for the production of a coating in accordance with the present invention. Once extended, protein chains can associate through hydrogen, ionic, hydrophobic and covalent bonding. Protein chain interactions contribute to the cohesion of the coating. In this regard, it is particularly desirable for the denaturation process to expose thiol-groups provided by cysteine and/or cysteine residues to enable disulfide formation. Also, any hydrophobic groups provided by glycine, alanine, valine, leucine and isoleucine (i.e. those amino acids having aliphatic substituents) are also ideally exposed to permit hydrophobic bonding between protein chains. The hydrophobic groups are often located towards the centre of globular proteins in the natural state. Furthermore, the protein may include serine, threonine, asparagine and glutamine, which have hydrophilic substituents that are capable of forming hydrogen bonds.

In the present invention, the protein is denatured to expose thiol-groups of the protein and to enable disulfide formation. Disulfide formation refers to the formation of new —S—S— bonds which can occur either intermolecularly or intramolecularly. Disulfide formation can take place via thiol oxidation reactions in which the free sulfhydryl groups of cysteine residues become oxidized and form disulfide bonds. Additionally, thiol-disulfide exchange reactions can take place wherein existing intramolecular disulfide bonds can react with a thiol group thus forming a new disulfide bridge and releasing another free thiol group. For example, the whey protein β-lactoglobulin can be used in the present invention as this protein normally contains two pairs of cysteine residues that form disulfide bridges and one cysteine residue that contains a free thiol group.

The protein is denatured so as to sufficiently disrupt the quaternary, tertiary and secondary structures of the protein so that the thiol groups of the protein have the ability and conformational accessibility required to form disulfide bridges. Without being bound by theory, it is believed that the denatured protein molecules may cross-link to form aggregates distributed within the solvent/carrier.

The denaturation treatment whereby the thiol-disulfide exchange is effected can be a heat treatment, a chemical treatment or an enzymic treatment. In the present invention, the denaturation treatment is preferably a heat treatment. When a heat treatment is used, the protein solution or dispersion will be heated to a temperature above the denaturation temperature of the particular protein for a period of time sufficient to initiate disulfide cross-linkage reactions. The precise temperature and length of time for a given protein can be determined empirically. However, it is anticipated that the denaturation process will typically involve temperatures of from about 65° C. to 100° C., preferably from about 70° C. to 100° C., more preferably about 90° C. The duration of the heat treatment may be up to 3 hours, preferably from about 15 to 45 minutes, more preferably about 30 minutes.

Interactions between denatured protein chains are affected by the degree of chain extension and the nature and sequence of amino acid residues. In some embodiments, it may be desirable to use a mixture of proteins from different sources to optimize the protein chain interactions between the amino acid residues. For example, it can be desirable to produce a coating using pea protein due to its hypoallergenic properties. However, pea protein has low amounts of cysteine, which may limit the ability of this protein to form disulfide cross-linkages. In contrast, rice protein has high levels of cysteine, which may lead to excessive cross-linkages leading the final coating to be brittle. In order to optimize the level to disulfide cross-linkages a combination of pea and rice protein may be used.

The coating composition of the present invention comprises, as an ingredient in addition to denatured protein, at least one lipid. Suitable lipids may include, but are not limited to, oils, waxes, fatty acids, fatty alcohols, monoglycerides and triglycerides, which are either saturated or unsaturated. In some embodiments, a blend of lipids may be used.

In general, the lipid or lipids selected for use in the coating composition will be liquid. That is, a lipid that has a melting point of 25° C. or less, preferably 10° C. or less. In some embodiments, it is preferred that the lipid has a melting point lower than the storage temperature of the coated product. Liquid lipids are often selected as they may be more readily blended with the other components of the coating composition compared to solid lipids. Solid lipids may need to be heated to above their melting temperature or dissolved in a suitable solvent, which may be another lipid or a portion of the carrier, in order to be effectively incorporated into the coating composition. Typically, if a solid lipid is used, it is first blended with a suitable solvent (such as a liquid lipid) so as to produce a lipid mixture that is liquid at 25° C. or less, preferably 10° C. or less.

Liquid lipids may also be more readily digested by the human or animal ingesting the coated product. Thus, the selection of a liquid lipid may be useful to ensure that any actives in the coated product are released at an optimum time.

Lipids used in embodiments of the invention can be derived from many different sources. In some embodiments, lipids used in embodiments of the invention can include biological lipids. Biological lipids can include lipids (fats or oils) produced by any type of plant, such as vegetable oils, or animal. In one embodiment, the biological lipid used includes triglycerides.

Many different biological lipids that are derived from plants may be used, and these plants may be genetically modified crops. By way of example, suitable plant-based lipids may include soybean oil, canola oil, cottonseed oil, grape seed oil, mustard seed oil, corn oil, linseed oil, safflower oil, sunflower oil, poppy seed oil, pecan oil, walnut oil, peanut oil, rice bran oil, camellia oil, olive oil, palm oil, palm kernel oil and coconut oil, or combinations thereof. Other suitable plant-based lipids may be obtained from almond, argan, avocado, babassu, beech, ben (from the seeds of the Moringa oleifera), borneo tallow nut, brazil nut, camelina, caryocar (pequi), cashew nut, cocoa, cohune palm, coriander, cucurbitaceae (e.g. butternut squash seed oil, pumpkin seed oil and watermelon seed oil), hemp, kenaf, macadamia, noog abyssinia, perilla, pili nut, quinoa, sacha inchi, seje, sesame, shea nut, tea seed and papaya seed. These may be used alone or in combination with another lipid.

Lipids derived from animals may also be used, for example, white grease, lard (pork fat), tallow (beef fat), anhydrous milk fat, and/or poultry fat may be used. However, as noted above, liquid lipids with a melting point of 25° C. or less are preferred.

The lipid may be synthetic triglyceride of the formula

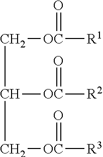

wherein R¹, R² and R³ may be the same or different and are aliphatic hydrocarbyl groups that contain from 7 to about 23 carbon atoms. The term “hydrocarbyl group” as used herein denotes a radical having a carbon atom directly attached to the remainder of the molecule. The aliphatic hydrocarbyl groups include the following:
(1) Aliphatic hydrocarbon groups; that is, alkyl groups such as heptyl, nonyl, undecyl, tridecyl, heptadecyl; alkenyl groups containing a single unsaturated bond such as heptenyl, nonenyl, undecenyl, tridecenyl, heptadecenyl, heneicosenyl; alkenyl groups containing plural unsaturated bonds; and all isomers thereof.
(2) Substituted aliphatic hydrocarbon groups containing non-hydrocarbon substituents, such as hydroxy of carbalkoxy groups.
(3) Hetero groups; that is, groups which, while having predominantly aliphatic hydrocarbon character, contain atoms other than carbon, such as oxygen, nitrogen or sulfur, present in a chain or ring otherwise composed of aliphatic carbon atoms.

Many biological lipids need to be processed following extraction from their natural source in order to remove impurities. For example, the lipids may be degummed to remove phospholipids, bleached to remove impurities and minor components such as chlorophyll and carotenoids that can give colour to the oil and fractionated to remove the free fatty acids that can give an undesirable taste and/or smell to the refined oil. “Fractionating” and related terms, as used herein, refer to a process in which less volatile components are separated from more volatile components, typically comprising the separation of triglycerides from free fatty acids in plant-derived biological lipids oils.

Processing can include hydrogenation of the lipid. In this process, the lipid is hydrogenated by reducing the unsaturated bonds in the lipid. This usually achieved by exposing the lipid to hydrogen in the presence of a catalyst, such as a nickel catalyst. Hydrogenation may be complete or partial. A partially hydrogenated lipid may include a blend of unhydrogenated lipid and fully hydrogenated lipid.

Hydrogenating the lipid can be advantageous as it reduces the lipid's sensitivity to oxidation. Some lipids are particularly susceptible to oxidation, leading to them going rancid and producing an objectionable flavour, and hydrogenation of these lipids may be useful. However, hydrogenation can increase the melting point of the lipid, thus transforming a liquid lipid into a solid one, which can affect the ease with which the lipid may be blended with other components of the composition. Accordingly, the degree to which a lipid may be hydrogenated will be selected bearing in mind the impact any increase in melting point will have on the ease with which the lipid can then be incorporated into the coating composition, as well as the effect this may have on the properties of the coating formed using the coating composition of the present invention.

Preferred lipids may include oxidatively stable, natural, synthetic, or hydrogenated and/or fractionated lipids including, for example, soybean oil, palm oil, palm kernel oil, sunflower oil, corn oil, canola oil, cottonseed oil, peanut oil, and the like, as well as mixtures thereof. Preferred lipids should be stable against oxidation or hydrolysis and may include canola oil, palm oil, palm kernel oil, partially hydrogenated soybean oil, and mixtures thereof. In some embodiments of the present invention, canola oil may be particularly preferred.

The inclusion of a lipid in the coating composition of the present invention has a beneficial impact upon the quality of the final coating on the coated product. A coating composition of carrier, denatured protein, polyol plasticizer and trehalose, without a lipid, can produce a grainy coating.

It is important to ensure that the lipid is well blended into the coating composition. A poor blend may result in an uneven coating on the coated product. For example, if the lipid is a solid lipid, the lipid rich portion of a poorly blended composition may form a platelet or particle of solid lipid that is transferred onto the product. It has been found that certain lipids, such as canola oil, can be readily blended into the coating composition to produce a smooth composition.

Typically, once the lipid is suitably blended into the coating composition, the coating composition will be smooth and stabile. In some embodiments, the lipid is blended with the denatured protein and carrier mixture before the polyol plasticizer or trehalose is added. Without being bound by theory, it is believed that the lipid can be blended with the denatured protein to form a smooth and stable composition due to interactions between the lipid and hydrophobic groups of the protein, such as the aliphatic substituents of glycine, alanine, valine, leucine and isoleucine. That is, the combination of hydrophilic and hydrophobic groups in the protein enables it to act as an emulsifier to facilitate the blending of the lipid with the carrier, which is often water. Once again without being bound by theory, it is thought that aggregates of denatured protein and lipid droplets may form micelles, bilayer vesicles or bilayers that are structured so that the lipid is “shielded” from the solvent/carrier. These structures may be carried through into the ultimate coating formed by the coating composition. Thus, in the ultimate coating, the lipid may be partially or fully encapsulated within the denatured protein.

Blending the lipid and the denatured protein, together with some or all of the carrier, prior to adding other components of the coating composition may enable the lipid and protein to interact more effectively in order to form the lipid “shielding” structure. This structure can then be stabilised through the addition of trehalose and the polyol plasticizer.

Blending the lipid with the denatured protein before incorporating the polyol plasticizer and trehalose into the coating composition may ensure that there is better contact between the lipid and the denatured protein, thus improving the texture of the resulting emulsion. That is, by ensuring that the lipid is well emulsified into the denatured protein mixture before incorporating other ingredients it may be possible to provide a coating composition with improved texture. In particular, it may be possible to obtain a coating composition with no visible graininess.

The strong interactions between the cross-linked protein chains enable the coating to act as a good oxygen, lipid and flavour barrier. However, the hydrophilic groups of the protein lead to the protein being susceptible to moisture ingress. The lipid compensates for this susceptibility as lipids can act as good moisture barriers, but are poor gas, lipid, and flavour barriers. Thus, the coating composition of the present invention may provide a coating having good oxygen, moisture, lipid and flavour barrier properties.

Insofar as the lipid of the composition is shielded by the denatured protein, the lipid benefits from the barrier properties of the protein. In particular; the denatured protein may act as a barrier to oxygen so as to limit or prevent oxidation of the lipid. In this way, the coating composition may prevent or reduce flavours, particularly objectionable flavours, developing in the lipid.

The lipid may be blended with the denatured protein mixture (i.e. the denatured protein and total amount of carrier) at a ratio of lipid:denatured protein mixture of between about 20:80 to about 50:50. In some embodiments, the ratio of lipid:denatured protein mixture is preferably about 35:65 to about 45:55, more preferably about 40:60, on a weight basis. In some embodiments, the ratio of lipid:denatured protein mixture is preferably about 25:75 to about 40:60, more preferably about 20:60, on a weight basis. The lipid and the denatured protein, together with some or all of the carrier, may be blended so as to form a smooth and stable emulsion using techniques that will be known to those skilled in the art.

In order to improve the flexibility of the ultimate coating, the composition of the present invention includes a polyol plasticizer. Polyols improve the flexibility of the coating by hydrogen bonding with the denatured proteins, thereby increasing the intermolecular spacing between the protein chains. Suitable polyols plasticizers include polyalcohols such as glycerol, sorbitol and polyethylene glycol, as well as combinations thereof. Glycerol is a preferred plasticizer in certain embodiments.

The polyol plasticizer may be blended with the denatured protein mixture. Alternatively, it may be added after the denatured protein mixture has been blended with the lipid. Often the polyol plasticizer is blended with the denatured protein before trehalose is added. The polyol plasticizer may be added at a ratio of polyol plasticizer:denatured protein mixture of between about 20:80 to about 50:50. In some embodiments, the ratio of polyol plasticizer:denatured protein mixture is preferably about 35:65 to about 45:55, more preferably about, 40:60, on a weight basis. In some embodiments, the ratio of polyol plasticizer:denatured protein mixture is preferably about 25:75 to about 40:60, more preferably about 20:60, on a weight basis. In some embodiments, the same weight of polyol plasticizer as lipid is used, for example in embodiments where the polyol plasticizer is glycerol and the lipid is a biological lipid such as canola oil.

The coating composition of the present invention further comprises, as an ingredient, trehalose. Trehalose is a bisacetal, non-reducing homodisaccharide in which two glucose units are linked together in a α-1,1-glycosidic linkage. The US Food and Drug Administration granted trehalose generally recognized as safe status in 2000. Trehalose stabilizes the denatured protein and improves the barrier properties of the coating formed using the coating composition of the present invention.

Trehalose is a kosmotrope, thus the interaction between trehalose/water is much stronger than water/water interaction. Accordingly, trehalose causes “destructuring” of the water network and ordering the water molecules around itself (as a kosmotrope). Without being bound by theory, it is believed that, where water is the carrier of the coating composition and present in excess, trehalose does not interact directly with the denatured protein. Instead, water is excluded from around the protein and is ordered around trehalose. In accordance with this theory, the concentration of trehalose in the coating composition is selected such that there is competition between trehalose and the denatured protein for the available water. This competition causes water molecules to be destructured around denatured protein and “structured” around trehalose. It is believed that trehalose manipulates the water structure around itself, such that the denatured protein is stabilized. Though the distribution of water molecules around trehalose will not be uniform, they may be oriented around trehalose in such a way that an ordered structure, with hydrogen bonds in all directions, is formed.

Furthermore, trehalose is believed to substitute carrier molecules, such as water or ethanol, around the protein. By replacing carrier molecules with trehalose molecules that provide a hydrogen-bonding network, the three-dimensional structure of the denatured protein may be maintained as the coating dries and as the coating is subjected to other stresses, such as thermal stresses. Trehalose may have both cryoprotective and lyoprotective properties.

The trehalose may stabilize the interaction between the denatured protein and the lipid so that the lipid may be well distributed throughout the carrier and the coating composition remains a smooth and even emulsion. Thus, trehalose may facilitate the coating composition having sufficient stability to allow it to be stored for extended periods without separating. For example, coating compositions of the present invention may be stored ready for use at 4° C. for two weeks or more, potentially four weeks or more, without separation or precipitation.

With further reductions in carrier levels as the coating dries, the trehalose may further stabilize the denatured protein and other components of the coating composition by immobilizing them inside a glassy sugar matrix. Trehalose can transit between one crystalline form and another, without relaxing its structural integrity, which is believed to facilitate formation of the protective glassy trehalose matrix around the other components of the coating.

Formation of the glassy matrix is believed to enhance the oxygen, lipid and flavour barrier properties provided by the cross-linked denatured protein by preserving the three dimensional structure of the denatured protein and protecting it from abiotic stresses. In doing so, the trehalose may enable the denatured protein to better protect the lipid and immobilize any diffusion of the lipid or polyol plasticizer from the coating. By preventing or reducing diffusion of the polyol plasticizer into, for example, a porous substrate such as an alginate based microparticle, the intermolecular spacing of the protein chains is maintained so that the coating remains flexible. Accordingly, the trehalose maintains the structure of the ultimate coating so that it has long term stability and resilience. Also, as the trehalose has replaced carrier molecules around the protein chains, the intermolecular spacing may be closer to that of a solvated protein. Thus, trehalose can complement the polyol plasticizer to provide a flexible coating.

Furthermore, the glassy matrix itself may inhibit the diffusion of oxygen, lipids or flavour compounds through the coating. Therefore, the denatured protein and the trehalose can combine to form a dense matrix with good oxygen, lipid and flavour barrier properties. This dense matrix supports the lipid, which in turn affords good moisture barrier properties to the coating.

The glassy matrix comprises trehalose partly in an amorphous glassy phase and partly in a crystalline hydrate phase. The crystalline hydrate phase serves as an agent to dehydrate the amorphous phase, thereby enhancing the glass transition temperature of the amorphous glassy state. As used herein, the term glass or glassy state means a liquid phase of such high viscosity and low water content that all chemical reactions may be slowed to a near standstill. The advantage of the glassy matrix in achieving long term stability results from the fact that diffusion in glassy (vitrified) materials occurs at extremely low rates (e.g., microns/year). Trehalose has the highest glass transition temperature (T_{g}) of all the disaccharides. The optimal benefits of vitrification, that is immobilization of other components by the glassy matrix, for long-term storage are observed under conditions where T_{g}, is greater than the storage temperature. As trehalose has a high T_{g}, the coating composition may be stabilized over a wide range of storage temperatures.

The structure of the coating may be such that the denatured protein, polyol plasticizer and glassy trehalose matrix surround dispersed droplets of the lipid. Without being bound by theory, it is thought that aggregates of denatured protein and lipid droplets may form micelles, bilayer vesicles or bilayers that are structured so that the lipid is “shielded” from the carrier. These droplets of lipid will have a lower tensile modulus compared to the denatured protein, polyol plasticizer and glassy trehalose matrix. Thus, the lipid may reduce the stiffness of the coating and improve toughness.

In addition, despite trehalose's affinity for water, this disaccharide may enhance the coating's resilience to moisture. As noted above, trehalose has the highest T_{g} of all the disaccharides. In general, the addition of water to an amorphous substance increases its mobility leading to a decrease in glass transition temperature (T_{g}). Though this anticipated decrease does occur in the case of trehalose, its T_{g} is still much higher than that of other disaccharides such as sucrose or maltose. Accordingly, even though moisture may decrease T_{g} it will typically remain higher than the storage temperature of the coated products so that coating will resist degradation.

Trehalose has a relative sweetness that is 45% that of sucrose and is effective at masking any flavours that may be associated with other components of the coating composition or an active in the coated product. For example, denatured proteins may have objectionable flavours. Proteins such as whey proteins often have a “cardboard” like taste, while rice proteins may have a chalky flavour. The objectionable flavour of the denatured protein may be effectively masked by the trehalose so that it is not perceived by the human or animal ingesting it.

Furthermore, trehalose may interact with the lipid in order to suppress or prevent oxidation. That is, trehalose may stabilize unsaturated bonds in the lipid against oxidation. As oxidation of the lipid can lead to the generation of volatile aldehydes that have objectionable flavours, suppressing oxidation of the lipid prevents objectionable flavours from developing or reduces their development.

It is envisioned that any active of the coated product will be effectively prevented from diffusing or leaking out of the coating, so any flavour compounds associated with the active should also be prevented from diffusing of leaking out by the coating. That being said, the process of ingesting the coated product may break the coating; for example if the coated product is chewed, and in those circumstances trehalose may effectively mask any objectionable flavour associated with the active in the coated product, or indeed any other component of the coated product.

Trehalose is typically added as the last ingredient to form the coating composition. However, it may be blended with the denatured protein mixture alone, or after either the lipid or polyol plasticizer has been added. Trehalose may be added at a ratio of trehalose:denatured protein mixture of between about 20:60 to about 60:40. In some embodiments, the ratio of trehalose:denatured protein mixture is preferably about 45:55 to about 55:45, more preferably about 50:50, on a weight basis. In some embodiments, the ratio of trehalose:denatured protein mixture is preferably about 25:60 to about 40:60, more preferably about 30:60, on a weight basis.

In some embodiments, the coating composition may include an emulsifier in order to enhance the stability of the lipid and denatured protein blend. An emulsifier may be added to enhance the stability of coating composition in general. The emulsifier may be any food-grade surface active ingredient, cationic surfactant, anionic surfactant and/or amphiphilic surfactant. Such emulsifiers can include one or more of, but are not limited to, lecithin, modified lecithin, chitosan, modified starches (e.g., octenylsuccinate anhydride starch), pectin, gums (e.g., locust bean gum, gum arabic, guar gum, etc.), alginic acids, alginates and derivatives thereof, cellulose and derivatives thereof, distilled monoglycerides, mono- and diglycerides, diacetyl tartaric acid esters of mono- and diglycerides (DATEM), polysorbate 60 or 80 (TWEEN 60 or 80), sodium stearyl lactylate, propylene glycol monostearate, succinylated mono- and diglycerides, acetylated mono- and diglycerides, propylene glycol mono- and diesters of fatty acids, polyglycerol esters of fatty acids, lactylic esters of fatty acids, glyceryl monosterate, propylene glycol monopalmitate, glycerol lactopalmitate and glycerol lactostearate, and mixtures thereof. In some embodiments, lecithin is used as an emulsifier. In some embodiments, TWEEN 80 is used as an emulsifier. The emulsifier, when used, may be added at a ratio of emulsifier:denatured protein mixture of between 0.1% to 0.2%, on a weight basis.

Other components that may be added to the coating composition depend upon the ultimate application of the coating composition. For example, in some embodiments the coating composition may include a colorant, such as when the coating composition is to be used to coat pharmaceutical or nutritional formulations that are provided as tablets.

Bearing in mind that the coating composition of the present invention is intended to be used on products to be ingested by humans or animals, once all components of the coating composition are blended together, the coating composition is typically sterilized. The coating composition may be sterilized by heating it to above 80° C. for a suitable length of time. For example, the coating may be sterilized at 85° C. for 30 minutes. The trehalose in the coating composition suppresses the formation of further disulfide cross-links between the denatured protein chains. Thus, the trehalose prevents the denatured protein from excessively cross-linking during the sterilizing process, as excessive cross-linking would lead to embrittlement of the coating.

As noted above, the coating produced using the coating composition of the present invention may prevent any active of the coated product from diffusing or leaking out or significantly reduce or mitigate diffusion or leakage of the active. For example, when the coated product is an active containing microparticle that has been added to a beverage, the coating should prevent the active from diffusing or leaking out such that the active does not become exposed to a degrading environment that would lead to the beneficial activity of the active being lost. The coating may also prevent a degrading environment from developing within the product itself. For example, the coating may prevent or limit ingress of degrading compounds, such as oxygen or water, from the surrounding environment so as to prevent degradation of the active within the coated product. Thus, a degrading environment is one that may be within or external to the coated product and involves exposing the active to at least one degrading compound and/or degrading condition. For example, a degrading environment may be formed by exposing an active to moisture under certain temperature conditions. Use of the coating composition of the present invention may prevent or reduce exposure of the active to a degrading environment.

Furthermore, diffusion or leakage of the active may be prevented or limited such that no flavour from the active is perceived by a human or animal ingesting the product. In addition, the barrier properties of the coating may be such that individual flavour compounds that may be derived from the active are prevented or limited from diffusing or leaking through the coating.

The coating formed using the coating composition of the present invention may prevent or reduce exposure of the active to a degrading environment, which may result from active leakage or ingress of degrading compounds, for an extended period of time. Alternatively or additionally, diffusion or leakage of the active, or a component of the active, may be prevented or limited such that no flavour from the active is perceived by a human or animal ingesting the product even after the product has been stored for an extended period under suitable conditions. In some embodiments, the coated product may be stored without the active losing its beneficial activity and/or without the flavour of the active becoming perceivable for up to two months when suitable storage conditions are used. In some embodiments, the coated product may be stored without the active losing its beneficial activity and/or without the flavour of the active becoming perceivable for up to six months when suitable storage conditions are used. Suitable storage conditions may include storing the coated product at temperatures around −20° C. Suitable storage conditions may include vacuum packing the coated product in foil.

In some embodiments, the product coated with the coating composition may be added to another product, such as a beverage, to form a supplemented (fortified) product. The coating formed using the coating composition may prevent or reduce exposure of the active to a degrading environment for the typical shelf life of the supplemented product. That is, the beneficial activity of the active may be preserved for the entire shelf life of the supplemented product through the use of the coating. Alternatively or additionally, diffusion or leakage of the active may be prevented or limited such that no flavour from the active is perceived by a human or animal ingesting the supplemented product. Accordingly, in some embodiments, the shelf life of the product to be supplemented is not affected by the supplementation (fortification) with the coated product. The supplemented product may be stored at around 15° C. or below, around 10° C. or below, preferably 4° C. or below.

In some embodiments, the product having a coating formed using the coating composition of the present invention is an active-containing microparticle. The coated microparticle may be added to another product, such as a beverage, to form a supplemented (fortified) product. In those embodiments, up to 10 grams of microparticles may be added per kilogram or per litre of product to be supplemented. For example, from about 7 grams to about 9 grams of coated microparticles may be added per kilogram or per litre of product to be supplemented. About 8 grams of coated microparticles may be added per kilogram or per litre of product to be supplemented. In some embodiments, 8 grams of coated microparticles are added per litre of juice, such as fresh orange juice, to be supplemented.

As an example, the coating of the present invention may be used on an active-containing microparticle that is added to a beverage to form a beverage supplemented with the active. The coating may have sufficient stability that the supplemented beverage may be stored for a number of weeks. For example, where the beverage is a fruit juice, such as a fresh fruit juice, the juice may be stored for around four weeks, preferably up to two months, more preferably up to three months, without the active losing its beneficial activity and/or without the objectionable flavour of the active becoming perceivable.

Suitable actives may be selected from a variety of functional substrates that are conventionally provided in microencapsulated form for consumption or other use as might be necessary. Such actives include:
probiotics, such as bifidobacterium, lactobacillus casei, lactobacillus acidophilus, lactobacillus plantarum;
animal feed supplements;
plant concentrates, such as cranberry concentrate;
oils, such as fish oils e.g. (omega-3);
pharmaceuticals, such as ibuprofen and gentamicin;
enzymes, such as lysozymes and insulin; and
vitamins, such as vitamins A, E, D, K1, B12, B9, B1 and B6.

Vitamins which may be used as actives include vitamins A, vitamins B, vitamins D, vitamins E, vitamins K, and ubiquinones, for example.

The vitamins A include vitamins A such as retinal (vitamin A₁ alcohol), retinal (vitamin A₁ aldehyde), vitamin A₁ acid, 3-dehydroretinol (vitamin A₂ alcohol), and 3-dehydroretinal (vitamin A₂ aldehyde) and provitamins A such as β-carotene (β, β-carotene), α-carotene (β, ε-carotene) and γ-carotene (β, ψ-carotene), for example. A provitamin A, such as β-carotene, may be a particularly preferred active for use with the coating composition of the present invention.

Vitamins B include Vitamin B₁ (thiamine), Vitamin B₂ (riboflavin), Vitamin B₃ (niacin or niacinamide), Vitamin B₅ (pantothenic acid), Vitamin B₆ (pyridoxine, pyridoxal, or pyridoxamine, or pyridoxine hydrochloride), Vitamin B₇ (biotin), Vitamin B₉ (folic acid) and Vitamin B₁₂ (various cobalamins, such as cyanocobalamin).

The vitamins D include vitamins D such as vitamin D₂, vitamin D₃, vitamin D₄, vitamin D₅, vitamin D₆, and vitamin D₇ and provitamins thereof, for example.

The vitamins E include tocopherols such as α-tocopherol, β-tocopherol, γ-tocopherol, and δ-tocopherol and tocotrienols such as α-tocotrienol, β-tocotrienol, γ-tocotrienol, and δ-tocotrienol, for example.

The vitamins K include vitamin K₁ and vitamins K₂, for example.

The ubiquinones include ubiquinone-1 to ubiquinole-12 (Q-1 to Q-12) and the oxidized forms thereof and amino chloride compounds thereof, for example.

The product to be coated may include one or more actives. In some embodiments, the active(s) may constitute a substantial portion of or the entirety of the product to be coated.

As noted above, certain actives may produce an objectionable flavour following degradation through exposure to, for example, moisture and/or oxygen. Thus, by preventing or limiting exposure to a degrading environment, the coating composition of the present invention may be used to prevent objectionable flavours from developing.

The coating composition of the present invention may be particularly suited to coating products containing actives that are susceptible to oxidative degradation, such as fish oil.

As used herein, the term “fish oil” means oil derived from fish and/or other marine organism(s). For example, fish oil includes oil derived from krill, calamari (squid), caviar, abalone scallops, anchovies, catfish, clams, cod, herring, lake trout, mackerel, menhaden, orange roughy, salmon, sardines, pilchards, sea mullet, sea perch, shark, shrimp, trout and tuna, and combinations thereof.

Fish oil is a source of omega-3 fatty acid. Other sources of omega-3 fatty acid include, but are not limited to, vegetable oils such as flaxseed oil, chia (typically Salvia hispanica) seed oil and hemp seed oil.

The coating composition of the present invention may be used to coat products containing sources of omega-3 fatty acids, such as the fish and vegetable oils described above.

When a source of omega-3 fatty acid is a fish oil or vegetable oil, the oil may be a crude oil, a partially refined oil, a refined oil, or an oil concentrate.

The term “omega-3 fatty acid” means a long chain polyunsaturated fatty acid having a carbon-carbon double bond between the third and fourth carbon from the methyl terminus of the fatty acid chain. Common omega-3 fatty acids include alpha linolenic acid (C18:3; (9Z,12Z,15Z)-Octadeca-9,12,15-trienoic acid, “ALA”), eicosapentaenoic acid (C20:5; (5Z,8Z,11Z,14Z,17Z)-icosa-5,8,11,14,17-pentaenoic acid, “EPA”), and docosahexaenoic acid (C22:6; (4Z,7Z,10Z,13Z,16Z,19Z)-docosa-4,7,10,13,16,19-hexaenoic acid, “DHA”). Other common omega-3 fatty acids include, but are not limited to, stearidonic acid (C18:4), eicosatetraenoic acid (C20:4), and docosapentaenoic acid (C22:5).

Fish oil may inherently have an objectionable flavour. However, the flavour of the fish oil may become more objectionable if the fish oil oxidizes. Therefore, the coating composition may be advantageous for use with a product containing fish oil as it provides an effective oxygen barrier to prevent or suppress oxidation of the fish oil. To the extent that the fish oil may diffuse out of the body coated with the coating composition so that the fish oil comes into contact with the coating composition, the trehalose of the coating composition may interact with the fish oil. As a result of this interaction, oxidation of the fish oil may be further suppressed. In addition, the trehalose may mask any objectionable flavour, including any objectionable smell, associated with the fish oil.

The coating composition may form a coating that masks the objectionable flavour of fish oil for up to two months under suitable storage conditions. In some embodiments, the coating formed using the coating composition may mask the objectionable flavour of fish oil for up to six months under suitable storage conditions. Suitable storage conditions may include storing the coated product at temperatures around −20° C. Suitable storage conditions may include vacuum packing the coated product in foil.

In some embodiments, the coating composition is used to coat microparticles that are then added to a beverage, such as fruit (e.g. orange) juice. In those embodiments, the coating formed using the composition of the present invention may mask the flavour of fish oil for the shelf life of the beverage. In some embodiments, the flavour is masked for up to four weeks. Preferably, the flavour is masked for up to two months, more preferably up to three months.

Other actives having objectionable flavours include vitamins B, which may have a bitter flavour.

The coating composition may be particularly useful for coating products containing probiotics. Probiotics are defined as live microbes that beneficially affect the human or animal that has ingested it by modulating mucosal and systemic immunity, as well as improving intestinal function and microbial balance in the intestinal tract. Probiotics can exhibit one or more of the following non-limiting characteristics: non-pathogenic or non-toxic to the host; are present as viable cells, preferably in large numbers; capable of survival, metabolism, and persistence in the gut environment (e.g., resistance to low pH and gastrointestinal acids and secretions); adherence to epithelial cells, particularly the epithelial cells of the gastrointestinal tract; microbicidal or microbistatic activity or effect toward pathogenic bacteria; anticarcinogenic activity; immune modulation activity, particularly immune enhancement; modulatory activity toward the endogenous flora; enhanced urogenital tract health; antiseptic activity in or around wounds and enhanced would healing; reduction in diarrhea; reduction in allergic reactions; reduction in neonatal necrotizing enterocolitis; reduction in inflammatory bowel disease; and reduction in intestinal permeability. The probiotic used as an active in the present invention may be selected from, but not limited to, the group consisting yeasts such as Saccharomyces, Debaromyces, Candida, Pichia and Torulopsis, moulds such as Aspergillus, Rhizopus, Mucor, and Penicillium and bacteria such as the genera Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pediococcus, Micrococcus, Leuconostoc, Weissella, Aerococcus, Oenococcus and Lactobacillus, as well as combinations thereof.

Examples of suitable probiotics include: Saccharomyces cereviseae (boulardii), Bacillus coagulans, Bifidobacterium animal's, Bifidobacterium bifidum, Bifidobacterium breve, Bifidobacterium infantis, Bifidobacterium longum, Bifidobacterium lactis, Enterococcus faecium, Enterococcus faecalis, Lactobacillus acidophilus, Lactobacillus alimentarius, Lactobacillus casei subsp. casei, Lactobacillus casei Shirota, Lactobacillus curvatus, Lactobacillus delbruckii subsp. lactis, Lactobacillus farciminus, Lactobacillus fermentum, Lactobacillus gasseri, Lactobacillus helveticus, Lactobacillus johnsonii, Lactobacillus paracasei, Lactobacillus plantarum, Lactobacillus reuteri, Lactobacillus rhamnosus (Lactobacillus GG), Lactobacillus sake, Lactobacillus salivarius, Lactococcus lactis, Pediococcus acidilactici, Pediococcus pentosaceus, Pediococcus acidilactici, Pediococcus halophilus, Streptococcus faecalis, Streptococcus thermophilus and Saccharomyces boulardii. More specifically the probiotic may selected from the group comprising of Lactobacillus casei Lc431, Lactobacillus rhamnosus CGMCC 1.3724, Bifidobacterium lactis BB12, Bifidobacterium lactis CNCM I-3446, Bifidobacterium longum ATCC BAA-999, Lactobacillus paracasei CNCM I-2116, Lactobacillus johnsonii CNCM I-1225, Lactobacillus fermentum VRI 003, Bifidobacterium longum CNCM I-2170, Bifidobacterium longum CNCM I-2618, Bifidobacterium breve, Lactobacillus paracasei CNCM I-1292, Lactobacillus rhamnosus ATCC 53103, Enterococcus faecium SF 68, Lactobacillus reuteri ATCC 55730, Lactobacillus reuteri ATCC PTA 6475, Lactobacillus reuteri ATCC PTA 4659, Lactobacillus reuteri ATCC PTA 5289, Lactobacillus reuteri DSM 17938, and mixtures thereof. In some preferred embodiments, the coated product may contain Lactobacillus casei Lc431 or Bifidobacterium lactis BB12.

A key problem associated with probiotic-containing products is ensuring that an adequate number of viable micro-organisms is provided by the product to the consumer. If the concentration of the viable probiotics in the food product does not exceed a certain threshold value, the beneficial effect of the probiotics is not provided. Temperature and exposure to oxygen, water and acids can affect probiotic viability. The probiotic is viable if it is alive and capable of reproduction or colonization. Quantities of probiotics are typically evaluated in terms of colony forming units (CFU). Typically, dosages of about one to two million CFU are required for adult humans to receive the beneficial effects of the probiotic.

The oxygen and moisture barrier properties of the ultimate coating provided by the coating composition may promote survival of the probiotic. Furthermore, the mechanical barrier provided by the coating may prevent or reduce diffusion of the probiotic into the surrounding environment, that will typically compromise probiotic viability. To the extent that the probiotic may diffuse out of the body coated with the coating composition so that the probiotic comes into contact with the coating composition, the trehalose of the coating composition may form a glassy matrix at the bacterial cell membrane to stabilise the probiotic and protect it from environmental stresses that would otherwise compromise probiotic viability. Furthermore, the polyol plasticizer and the trehalose may combine synergistically to enhance survival of the probiotic.

Accordingly, the present invention provides a method of maintaining probiotic viability or improving probiotic survival in a product containing a probiotic, said method comprising coating the product with the coating composition of the present invention. The use of the coating composition of the present invention to maintain viability or to improve survival of a probiotic in a product is also provided.

The amount of probiotic initially in a coated product may be from 6 log₁₀ CFU/g to 12 log₁₀ CFU/g. For example, the amount of probiotic initially in a coated product may be from 8 log₁₀ CFU/g to 11 log₁₀ CFU/g, such as from 9 log₁₀ CFU/g to 10 log₁₀ CFU/g. As noted above, the coating formed using the coating composition of the present invention may maintain viability and promote survival of the probiotic in storage. Probiotic survival is expressed as a percentage and is calculated according to Formula 1 below.

$$Probiotic Survival ( \% ) = 100 \times \frac{{log}_{10} ( \begin{matrix}final number of CFU \\ per unit weight or unit volume\end{matrix} )}{{log}_{10} ( \begin{matrix}initial number of CFU \\ per unit weight or unit volume\end{matrix} )} \qquad Formula 1$$

In some embodiments, the number of CFU of probiotic in a coated product may be maintained so that probiotic survival is 97% or more, for example around 100%, of the initial number of CFU after two months of storage under suitable conditions. In some embodiments, the number of CFU is maintained so that probiotic survival is 97% or more, for example around 100%, of the initial CFU level after six months of storage under suitable conditions. Suitable storage conditions may include storing the coated product at temperatures around −20° C. Suitable storage conditions may include vacuum packing the coated product in foil.

In some embodiments, the viability of the probiotic in the coated product is maintained such that the value of log₁₀ (final number of CFU per unit weight or unit volume) is ≦1 less than the value of log₁₀ (initial number of CFU per unit weight or unit volume), preferably the difference between the values is from 0 to 0.5, more preferably the difference is less than 0.02, even more preferably the difference is less than 0.004.

In addition, probiotics may have flavours that might be considered objectionable by humans or animals ingesting them and the coating may mask these flavours. The coating may prevent these flavours from emanating from the coated product by preventing diffusion of the probiotic from the coated product.

In some embodiments, the product to be coated is a probiotic-containing microparticle. The probiotic-containing microparticle may be added to a beverage to form a beverage supplemented with the probiotic. The coating may have sufficient stability that the shelf life of the beverage is not affected by the supplementation with the coated product. For example, where the beverage is a fruit juice, such as a fresh fruit juice, the juice may be stored for around four weeks, preferably up to two months, more preferably up to three months, without the probiotic losing its beneficial activity and/or without the flavour of the probiotic becoming perceivable. In some embodiments, the probiotic survival for the coated microparticles may be 60% or more, preferably 90% or more, for example around 99%, after four weeks of storage, preferably after up to two months of storage, of the supplemented beverage. The supplemented beverage may be stored at around 15° C. or below, around 10° C. or below, preferably 4° C. or below.

In some embodiments, the quantity of probiotic-containing microparticles added to a beverage is such that the amount of probiotic in the beverage may be from 5 log₁₀ CFU/mL to 10 log₁₀ CFU/mL. For example, the amount of probiotic in the beverage may be from 6 log₁₀ CFU/mL to 9 log₁₀ CFU/mL, such as about 7 log₁₀ CFU/mL.

In some embodiments, coating a product containing a probiotic with the coating composition of the present invention improves the survival of the probiotic in storage, when compared to a product without the coating. Improvement in probiotic survival is expressed as a percentage and is calculated according to Formula 2 below.

$$Improvement i n Probiotic Survival ( \% ) = 100 - ( 100 \times \frac{{log}_{10} ( \begin{matrix}number of CFU per unit weight \\ or unit volume of the uncoated product\end{matrix} )}{{log}_{10} ( \begin{matrix}number of CFU per unit weight \\ or unit volume of the coated product\end{matrix} )} ) \qquad Formula 2$$

In some embodiments, the improvement in probiotic survival is approximately 15% or more, preferably around 20% or more, more preferably around 30% or more and even more preferably around 40% or more. For example, in embodiments where the probiotic is Bifidobacterium lactis BB12, the improvement in probiotic survival following storage, when compared to a product without the coating, may be approximately 20%. In embodiments where the probiotic is Lactobacillus casei Lc431, the improvement in probiotic survival following storage, when compared to a product without the coating, may be approximately 40%.

The improvement in probiotic survival for a coated product vacuum packed in foil and stored at −20° C. may be at least 50%, preferably at least 75%, more preferably about 99% to 100% after two months of storage, preferably after 6 months of storage, when compared to an uncoated product under the same conditions. The improvement in probiotic survival for a coated product in juice and stored at 4° C. may be about 20% to 25% when the probiotic is Bifidobacterium lactis BB12 and about 30% to 35% when the probiotic is Lactobacillus casei Lc431 after four weeks of storage, preferably after up to two months of storage, when compared to an uncoated product under the same conditions.

For certain actives, in order to maximise absorption by human consumers, it can be desirable to transport the active(s) through the gastro-intestinal tract to the alkaline environment of the small intestine. For example, exposure to adverse conditions of the gastro-intestinal tract (e.g. exposure to gastric acid in the stomach) can compromise probiotic survival. Some actives can have an irritant effect on the stomach, so it is desirable to provide such actives in products where the active is not available for absorption until it reaches the small intestine. Actives with an objectionable flavour such as fish oil, if released in the stomach, can cause the objectionable flavour to emanate up the oesophagus and/or provoke a gastric reflux response causing the flavour to be perceived by the consumer. This effect is sometimes known as food “repeating” on the consumer.

In some embodiments, the coating formed from the coating composition of the present invention may be an enteric coating. Accordingly, the coating may allow the coated product to pass through the acidic conditions of the stomach without any active(s) contained in the product being released until the alkaline conditions of the small intestine is reached.

In some embodiments, the product to be coated may have enteric barrier properties and the coating formed of the coating composition of the present invention may enhance, facilitate or compliment those barrier properties. For example, as will be described in further detail below, the coating composition may be used to coat microparticles formed from alginates that encapsulate active(s). Alginates have enteric barrier properties. However, alginates can be porous and actives may leak out or diffuse from the microparticle. Similarly, degrading environmental factors, such as oxygen and moisture may diffuse into the microparticle compromising the microparticle in storage. A coating formed using the coating composition of the present invention may seal a product having enteric barrier properties so that viable actives remain within the product until such time as the product is consumed and the enteric properties of the product are utilised.

In some embodiments, the coating composition of the present invention prevents the flavour of the active(s) from emanating from the coated product in storage and the enteric barrier properties of the product within the coating prevent flavours from emanating in the stomach after consumption. In this way, the coating formed of the coating composition of the present invention may compliment the enteric barrier properties of the product that it coats.

The coating may be used to coat a variety of products including food stuffs and tablets or capsules. However, the coating composition is particularly suited to coating microparticles. In particular, the coating composition may be useful for coating microparticles formed of cross-linkable polymers selected from the class of hydrogels, including hydrocolloids. Hydrocolloids are hydrophilic polymers, of vegetable, animal, microbial or synthetic origin, that generally contain many hydroxyl groups and may be polyelectrolytes.

Polymers which may be used to prepare microparticles suitable for coating using the coating composition of the present invention include, but are not limited to, one or a mixture of polymers selected from the group consisting of polyvinyl alcohol, alginates, carrageens, pectins, carboxy methyl cellulose, hyaluronates, heparins, heparin sulfates, heparans, chitosans, carboxymethyl chitosan, agar, gum arabic, pullulan, gellan, xanthan, tragacanth, carboxymethyl starch, carboxymethyl dextran, chondroitins including chondroitin sulfate, dermatans, cationic guar and locust bean, konjac, gum ghatti, xyloglucans, karaya gums, cationic starch as well as salts and esters thereof.

Exemplary anionic polymers include one or a mixture of alginates, pectins, carboxy methyl cellulose, hyaluronates. Exemplary cationic polymers include chitosan, cationic guar, and cationic starch.

The ionically cross-linkable polymers from which the microparticles may be generated may be functionalised with carboxylic, sulfate, phosphate, sulphonamide, phosphonamido, hydroxy and amine functional groups.

The microparticles formed using hydrogels may be porous so actives are liable to leak out or diffuse from the microparticle. Likewise, degrading environmental factors, such as oxygen and moisture may diffuse into the microparticle. A coating formed using the coating composition of the present invention may seal the porous microparticle.

The microparticles can be manufactured using any of the techniques known to those skilled in the art. Moreover, embodiments of the coating composition may be particularly suited to coating edible microparticles manufactured using the method described in International Application No. PCT/AU2008/001695 (Publication No. WO 2009/062254), the entire contents of which are incorporated herein by reference.

The product to be coated may be coated by the coating composition of the present invention using a variety of techniques. Suitable coating techniques include, but are not limited to, immersion coating, partial immersion coating, dipping, brushing, spin coating, flow coating and spray coating. The technique used may be selected depending upon the nature of the product to be coated. For example, wet hydrogel microparticles may be partially immersed in the coating composition, mixed to ensure an even coating and then packaged.

The amount of coating composition used to coat a product may be equivalent to up to 50% of the weight of the product to be coated. In some embodiments, such as when the product to be coated is a microparticle, the amount of coating used may be equivalent to 20 to 40% of the weight of the product to be coated, preferably about 30% of the weight of the product to be coated.

The coated product may be stored at 4° C., preferably at −20° C.

In an embodiment of the invention the coating composition may itself include one or more actives. The actives may be as described above. When the coating composition is used to coat an active-containing microparticle, the active(s) in the coating composition may be the same or different category of active present in the microparticle. The active(s) for the coating composition must be compatible with the coating composition and should not compromise the intended efficacy of the coating composition.

The following non-limiting examples illustrate embodiments of the present invention.

### Example 1

### Whey Protein Isolates (WPI) Based Coating Composition

### Preparing the WPI Mixture

### Materials:

Whey protein isolates powder—10 g

Water—90 g

### Method:

A 10% WPI solution was prepared by mixing together the WPI powder and water. The mixture was allowed to stand for 30 minutes after mixing so that the WPI could rehydrate. After standing, the 10% WPI solution was heat treated at 90° C. for 30 minutes. The resulting 10% WPI mixture was cooled before use.

### Preparing the Coating Composition

### Materials:

10% WPI mixture as described above—60 g

Canola oil—40 g

Glycerol—40 g

Trehalose powder—60 g

### Method:

The canola oil was emulsified in the 10% WPI mixture for 5 minutes at high speed using an IKA® T25 Digital ULTRA TURRAX® high-performance single-stage dispersing machine supplied by IKA-Works, Inc.

Glycerol was added in to the emulsion followed by the trehalose powder. The mixture was continuously homogenized for 5 minutes at medium speed using the IKA® T25 Digital ULTRA TURRAX® high-performance single-stage dispersing machine. The resulting coating composition was then sterilised at 85° C. for 30 minutes. The coating solution was cooled to room temperature before use.

### Example 2

### Coating Microparticles

### Materials:

Wet microparticles manufactured using the method described in International Application No. PCT/AU2008/001695 (Publication No. WO 2009/062254) and comprising sodium alginate and pectin cross-linked using calcium chloride—100 g

Coating composition of Example 1—30 g

### Method:

The coating composition and microparticles were mixture together thoroughly by hand. After mixing, the coated microparticles were vacuum packed in foil and stored. Samples were stored at either at 4° C. or −20° C. It was found to be preferable to store the microparticles at −20° C.

### Example 3

### Whey Protein Isolates (WPI) Based Coating Composition

### Preparing the WPI Mixture

### Materials:

Whey protein isolates powder—10 g

Water—90 g

### Method:

A 10% WPI solution was prepared by mixing together the WPI powder and water. The mixture was allowed to stand for 30 minutes after mixing so that the WPI could rehydrate. After standing, the 10% WPI solution was heat treated at 90° C. for 30 minutes. The resulting 10% WPI mixture was cooled before use.

### Preparing the Coating Composition

### Materials:

10% WPI mixture as described above—60 g

Canola oil—20 g

Glycerol—20 g

Trehalose powder—30 g

### Method:

The canola oil was emulsified in the 10% WPI mixture for 5 minutes at high speed using an IKA® T25 Digital ULTRA TURRAX® high-performance single-stage dispersing machine supplied by IKA-Works, Inc.

Glycerol was added in to the emulsion followed by the trehalose powder. The mixture was continuously homogenized for 5 minutes at medium speed using the IKA® T25 Digital ULTRA TURRAX® high-performance single-stage dispersing machine. The resulting coating composition was then sterilised at 85° C. for 30 minutes. The coating solution was cooled to room temperature before use.

### Example 4

### Effect of Coating Microparticles

### Part 1: Uncoated Microparticles

Microparticles in which 2.5%, by weight, Lactobacillus casei Lc431 (Lc431) and 20%, by weight, fish oil were encapsulated within a matrix of sodium alginate and pectin cross-linked using calcium chloride were prepared using the method described in International Application No. PCT/AU2008/001695 (Publication No. WO 2009/062254).

Microparticles in which 2.5%, by weight, Bifidobacterium lactis BB12 (BB12) and 20%, by weight, fish oil were encapsulated within a matrix of sodium alginate and pectin cross-linked using calcium chloride were prepared using the method described in International Application No. PCT/AU2008/001695 (Publication No. WO 2009/062254).

Each type of microparticle was added to separate orange juice samples and the samples were tested for taste and smell quality during storage at 4° C. and 10° C. Orange juice samples containing the microparticles in which BB12 and fish oil were encapsulated were also assessed for survival of the probiotic during storage at 4° C. The amount of microparticles added to each orange juice sample was 2 g/250 mL.

Sensory evaluation detected fish oil smell and taste in all samples stored at both temperatures. Fish oil smell and taste became detectable after one week of storage at both 4° C. and 10° C.

The survival of the BB12 in the orange juice samples stored at 4° C. is shown in Table 1 below. The probiotic loadings are measured as colony forming units per milliliter (CFU/mL).

TABLE 1
Survival of probiotics in samples stored at 4° C.

| | | Probiotic Level | Probiotic Level | |
|---|---|---|---|---|
| | Initial Probiotic | after One Week of | after Two Weeks | Probiotic |
| Microparticle | Level (Day 0) | Storage. | of Storage. | Survival |
| Type | (Log₁₀ CFU/mL) | (Log₁₀ CFU/mL) | (Log₁₀ CFU/mL) | (%) |
| BB12 and | 6.38 | 4.59 | | 71.9% |
| Fish Oil | | | 2.70 | 42.3% |
| BB12 and | 8.35 | 7.57 | | 90.6% |
| Fish Oil | | | 4.46 | 53.4% |
| BB12 and | 6.36 | 5.74 | | 90.2% |
| Fish Oil | | | 3.67 | 57.7% |

### Part 2: Coated Microparticles

Microparticles in which 2.5%, by weight, Lc431 and 20%, by weight, fish oil were encapsulated within a matrix of sodium alginate and pectin cross-linked using calcium chloride were prepared using the method described in International Application No. PCT/AU2008/001695 (Publication No. WO 2009/062254). These microparticles were then coated with the coating composition of Example 1 by manually mixing together microparticles and the coating composition at a microparticle:coating composition ratio of 10:3 on a weight basis.

Microparticles in which 2.5%, by weight, BB12 and 20%, by weight, fish oil were encapsulated within a matrix of sodium alginate and pectin cross-linked using calcium chloride were prepared using the method described in International Application No PCT/AU2008/001695 (Publication No. WO 2009/062254). These microparticles were then coated with the coating composition of Example 1 by manually mixing together microparticles and the coating composition at a microparticle:coating composition ratio of 10:3 on a weight basis.

Coated microparticles were vacuum packed in foil and stored at 4° C. or −20° C. It was found to be preferable to store the microparticles at −20° C.

Coated microparticles were also added to juice samples that were stored at 4° C. and 10° C. The following juices were used: orange; orange and mango; apple and mango; cloudy apple and Berri “Multi-V Breakfast Juice” (“Multi-V” juice). The composition of the “Multi-V” juice was as follows: reconstituted fruit juices [apple (72.4%), orange (17%), grape (4%), apricot (2%), peach (2%), pear (0.5%), lemon (0.5%), mango (0.5%) and passionfruit (0.5%)], guava puree (0.5%), flavour, Vitamin C (10 mg/250 mL), Vitamin A (75 μg/250 mL), Food Acid (citric acid) and Folate (50 μg/250 mL). The amount of coated microparticles added to each juice sample was 2 g/250 mL.

All samples were tested for taste and smell quality during storage at the relevant temperature. The samples in juice were also tested to evaluate probiotic survival. In addition, the samples of microparticles stored in foil at −20° C. were also assessed for probiotic survival.

### Coated Microparticles Stored in Foil

Sensory evaluation did not detect any fish oil smell or taste following the initial evaluations at Day 0 and further evaluations after one month and after three months for the samples in storage at 4° C. and for the samples in storage at −20° C. Furthermore, the probiotic survival measurements for the samples stored at −20° C. for three months indicate that the probiotic levels decreased from 9.7 log₁₀ CFU/g to 9.5 log₁₀ CFU/g, which corresponds to about 98% probiotic survival.

### Coated Microparticles Added to Juice

Sensory evaluation could not detect fish oil smell or taste in any of the juice samples containing the coated microparticles. Sensory evaluation was conducted at Day 0, one week, two weeks, three weeks and four weeks.

The survival of the probiotics in the juice samples is shown in Tables 2 and 3 below.

TABLE 2
Survival of probiotics in juice samples stored at 4° C.

| | | Initial | | |
|---|---|---|---|---|
| | | Probiotic | | |
| | | Level | | |
| | | (Day 0) | Probiotic Level | Probiotic |
| | Juice | (Log₁₀ | after Storage. | Survival |
| Microparticle Type | Type | CFU/mL) | (Log₁₀ CFU/mL) | (%) |
| BB12 and Fish Oil | Orange | 8.33 | 6.77 after week 1 | 81.3% |
| (trial 28/05/12) | | | 5.39 after week 2 | 64.7% |
| Lc431 and Fish Oil | Orange | 7.92 | 7.95 after week 1 | 100% |
| (trial 28/05/12) | | | 7.85 after week 2 | 99.1% |
| Lc431 and Fish Oil | Multi-V | 7.22 | 6.67 after week 4 | 92.4% |
| (trial 17/08/12) | | | | |
| Lc431 and Fish Oil | Orange | 7.62 | 6.87 after week 4 | 90% |
| (trial 17/08/12) | and | | | |
| | mango | | | |
| Lc431 and Fish Oil | Orange | 7.43 | 7.54 after week 4 | 101.5% |
| (trial 28/08/12) | | | | |
| Lc431 and Fish Oil | Orange | 7.77 | 7.76 after week 4 | 99.9% |
| (trial 28/08/12) | | | | |
| Lc431 and Fish Oil | Apple | 7.64 | 7.36 after week 4 | 96.3% |
| (trial 11/09/12) | and | | | |
| | mango | | | |
| Lc431 and Fish Oil | Cloudy | 7.58 | 7.40 after week 4 | 97.6% |
| (trial 11/09/12) | apple | | | |

TABLE 3
Survival of probiotics in juice samples stored at 10° C.

| | | Initial | | |
|---|---|---|---|---|
| | | Probiotic | | |
| | | Level | | |
| | | (Day 0) | Probiotic Level | Probiotic |
| | Juice | (Log₁₀ | after Storage. | Survival |
| Microparticle Type | Type | CFU/mL) | (Log₁₀ CFU/mL) | (%) |
| BB12 and Fish Oil | Orange | 7.58 | 7.14 after day 4 | 94.2% |
| (trial 18/06/12) | | | | |
| Lc431 and Fish Oil | Orange | 7.49 | 7.18 after day 4 | 95.9% |
| (trial 18/06/12) | | | | |
| Lc431 and Fish Oil | Multi-V | 7.22 | 7.21 after day 10 | 99.9% |
| (trial 17/08/12) | | | | |
| Lc431 and Fish Oil | Orange | 7.62 | 7.01 after day 10 | 92% |
| (trial 17/08/12) | and | | | |
| | mango | | | |

### CONCLUSIONS

From a comparison of the sensory evaluation results of Part 1 and Part 2, it is clear that the coating composition of Example 1 may be used to form a coating that is effective at masking the objectionable flavour of fish oil.

As illustrated by the results in Table 1, probiotic survival in the samples of uncoated microparticles added to orange juice was around 50%, on average, after two weeks of storage at 4° C. In contrast, as shown in Table 2, when the coating composition of Example 1 was applied to microparticles containing BB12, probiotic survival improved to 64.7% after two weeks of storage. Furthermore, for microparticles containing Lc431, probiotic survival was 90% or more after four weeks in juice stored at 4° C. While at the higher storage temperature of 10° C., negligible cell losses corresponding to reductions in probiotic survival of 8% or less were observed (see Table 3). In conclusion, the coating composition of Example 1 may be used to form a coating that is effective at improving probiotic survival.

### Example 5

### Liquid Sweet Formula Supplemented by Microparticles

Microparticles in which 2.5%, by weight, Lactobacillus casei Lc431 (Lc431) and 10%, by weight, fish oil were encapsulated within a matrix of sodium alginate and pectin cross-linked using calcium chloride were prepared using the method described in International Application No. PCT/AU2008/001695 (Publication No. WO 2009/062254). These microparticles were then coated with the coating composition of Example 3 by manually mixing together microparticles and the coating composition at a microparticle:coating composition ratio of 10:3 on a weight basis.

The microparticles were added to a liquid sweet formula to produce a supplemented formula comprising, on a weight basis: 0.45% xanthan gum, 1.8% carrageenan gum, 2% fructose, 34% mango syrup and 13% microparticles, with the remainder being water. Once supplemented with the microparticles, the liquid sweet formula was packaged to produce 10 mL serving pouches. Each pouch contained 3 billion CFU of Lc431 and 100 mg DHA/EPA due to the supplementation by the microparticles.

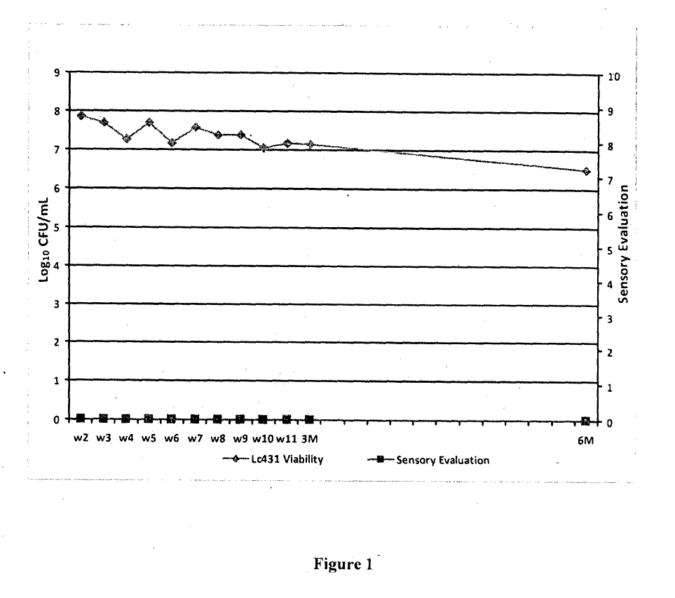

The pouches were stored at initially at room temperature for two weeks and then at 4° C. The samples were tested over a six month period to assess probiotic survival and whether the flavour (i.e. smell/taste) of the Lc431 and fish oil were perceptible. The results of these tests are shown below in Table 4 and in FIG. 1.

TABLE 4
Probiotic Viability and Flavour Perception Test Results.

| Measurement | Cell Viability | **Sensory |
|---|---|---|
| Date | (Log₁₀ CFU/mL) | Evaluation |
| Week 2* | 7.85 | 0 |
| Week 3 | 7.7 | 0 |
| Week 4 | 7.26 | 0 |
| Week 5 | 7.68 | 0 |
| Week 6 | 7.17 | 0 |
| Week 7 | 7.58 | 0 |
| Week 8 | 7.38 | 0 |
| Week 9 | 7.38 | 0 |
| Week 10 | 7.05 | 0 |
| Week 11 | 7.16 | 0 |
| Week 12 | 7.15 | 0 |
| Month 6 | 6.50 | 0 |

NB:
*Stability test was started after 2 weeks storage at room temperature.
**Sensory evaluation rated from 0 = flavour (i.e. smell/taste) of the active(s) not detected to 10 = flavour of the active(s) detected very readily.

### Example 6

### Thick Base Stick Supplemented by Microparticles

Microparticles in which 10%, by weight, fish oil was encapsulated within a matrix of sodium alginate and pectin cross-linked using calcium chloride were prepared using the method described in International Application No. PCT/AU2008/001695 (Publication No. WO 2009/062254). These microparticles were then coated with the coating composition of Example 3 by manually mixing together microparticles and the coating composition at a microparticle:coating composition ratio of 10:3 on a weight basis.

The microparticles were added to a thick base stick formulation to produce a supplemented formulation comprising: 0.4% xanthan gum, 1.5% stevia, 5% flavour solution, 0.1% potassium sorbet and 72% microparticles, with the remainder being water. Once supplemented with the microparticles, the thick base stick formulation was packages into 5 g serving pouches. Each 5 g serving of the formulation contained 300 mg DHA/EPA due to the supplementation by the microparticles.

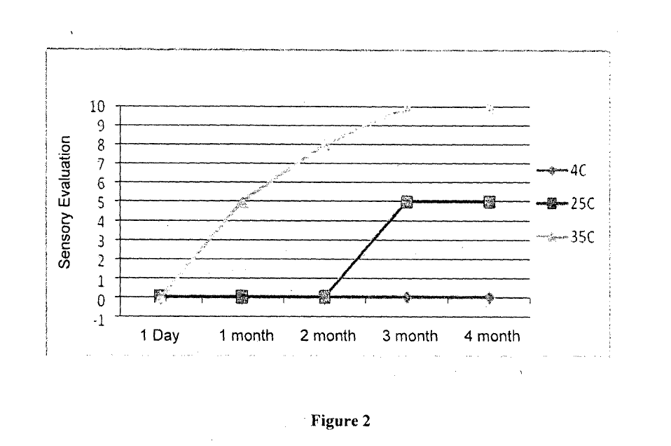

Five gram serving samples were stored at one of three temperatures: 4° C., 25° C. or 35° C.; and tested over a four month period to assess whether the flavour of the fish oil was perceptible. The sensory evaluation tests rated the sample from 0=flavour of the active(s) not detected to 10=flavour of the active(s) detected very readily. The results of these tests are shown in FIG. 2.

### Example 7

### Thin Base Drink Formula Supplemented by Microparticles

Microparticles in which 2.5%, by weight, Lactobacillus casei Lc431 (Lc431) was encapsulated within a matrix of sodium alginate and pectin cross-linked using calcium chloride were prepared using the method described in International Application No. PCT/AU2008/001695 (Publication No. WO 2009/062254). These microparticles were then coated with the coating composition of Example 3 by manually mixing together microparticles and the coating composition at a microparticle:coating composition ratio of 10:3 on a weight basis.

The microparticles were added to a thin base drink formula to produce a supplemented formula comprising, on a weight basis: 3% Whey Protein Isolate, 2% Litess II from DuPont™ Danisco®, 1% Prebiotic Hi-Maize® from National Starch, 4% trehalose, 0.75% stevia, 0.05% xanthan gum, 0.1% potassium sorbate and 2% microparticles, with the remainder being water.

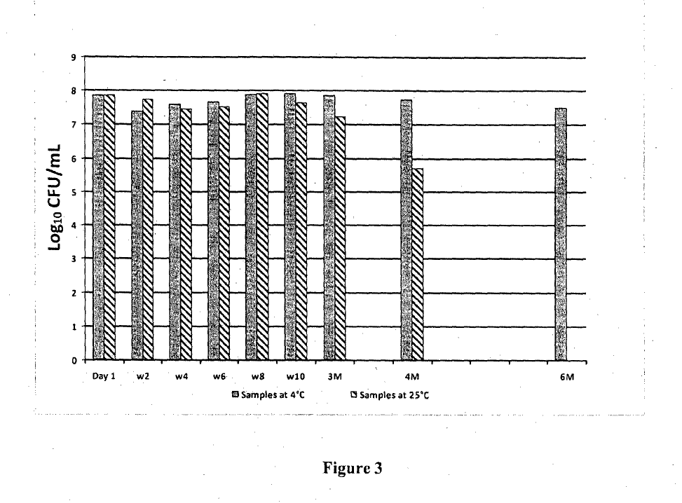

Samples of the supplemented thin base drink formula were stored at either 4° C. or 25° C. and tested over a six month period to assess probiotic survival. The results of these tests are shown below in Table 5 and in FIG. 3,

TABLE 5
Probiotic Viability Test Results.

| | | Cell Viability |
|---|---|---|
| | Cell Viability | for Samples |
| | for Samples | Stored at 25° C. |
| Measurement | Stored at 4° C. | storage |
| Date | (Log₁₀ CFU/mL) | (Log₁₀ CFU/mL) |
| Day 1 | 7.87 | 7.87 |
| Week 2 | 7.4 | 7.75 |
| Week 4 | 7.6 | 7.45 |
| Week 6 | 7.67 | 7.52 |
| Week 8 | 7.89 | 7.90 |
| Week 10 | 7.90 | 7.65 |
| Week 12 | 7.87 | 7.25 |
| Month 4 | 7.75 | 5.7 |
| Month 6 | 7.50 | |

### Example 8

### Thin Base Drink Formula Supplemented by Microparticles

Microparticles in which 2.5%, by weight, Lactobacillus casei Lc431 (Lc431) and 10%, by weight, fish oil were encapsulated within a matrix of sodium alginate and pectin cross-linked using calcium chloride were prepared using the method described in International Application No. PCT/AU2008/001695 (Publication No. WO 2009/062254). These microparticles were then coated with the coating composition of Example 3 by manually mixing together microparticles and the coating composition at a microparticle:coating composition ratio of 10:3 on a weight basis.

The microparticles were added to a thin base drink formula to produce a supplemented formula comprising, on a weight basis: 3% Whey Protein Isolate, 2% Litess II from DuPont™ Danisco®, 1% Prebiotic Hi-Maize® from National Starch, 4% trehalose, 0.75% stevia, 0.05% xanthan gum, 0.1% potassium sorbate and 2% microparticles, with the remainder being water.

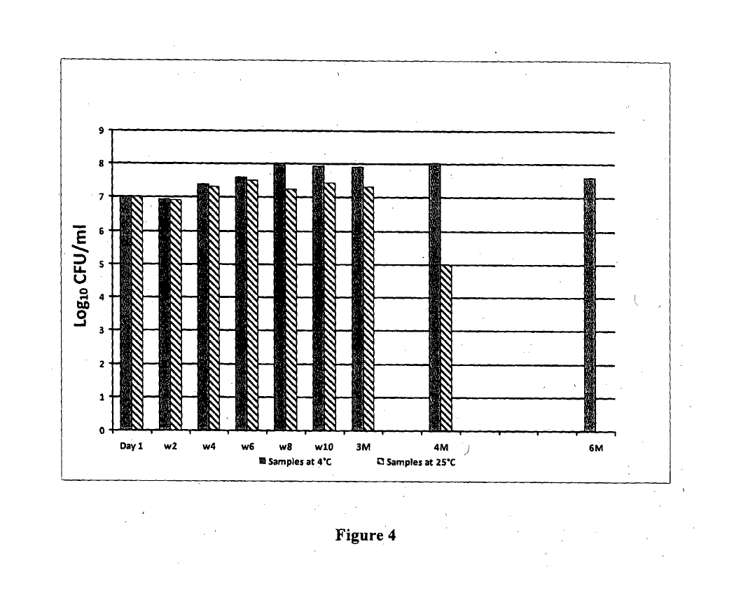

Samples of the supplemented thin base drink formula were stored at either 4° C. or 25° C. and tested over a six month period to assess probiotic survival. The results of these tests are shown below in Table 6 and FIG. 4,

TABLE 6
Probiotic Viability Test Results.

| | | Cell Viability |
|---|---|---|
| | Cell Viability | for Samples |
| | for Samples | Stored at 25° C. |
| Measurement | Stored at 4° C. | storage |
| Date | (Log₁₀ CFU/mL) | (Log₁₀ CFU/mL) |
| Day 1 | 7.00 | 7.00 |
| Week 2 | 6.95 | 6.92 |
| Week 4 | 7.39 | 7.33 |
| Week 6 | 7.61 | 7.50 |
| Week 8 | 7.95 | 7.24 |
| Week 10 | 7.94 | 7.44 |
| Week 12 | 7.92 | 7.33 |
| Month 4 | 8.04 | 5.00 |
| Month 6 | 7.61 | |

### Example 9

### Meal Replacement Protein Powder Supplemented by Microparticles

Microparticles in which 2.5%, by weight, Lactobacillus casei Lc431 (Lc431) was encapsulated within a matrix of sodium alginate and pectin cross-linked using calcium chloride were prepared using the method described in International Application No. PCT/AU2008/001695 (Publication No. WO 2009/062254). These microparticles were then coated with the coating composition of Example 3 by manually mixing together microparticles and the coating composition at a microparticle:coating composition ratio of 10:3 on a weight basis.

The microparticles were added to a commercially available meal replacement protein powder at a 1:49 ratio, by weight.

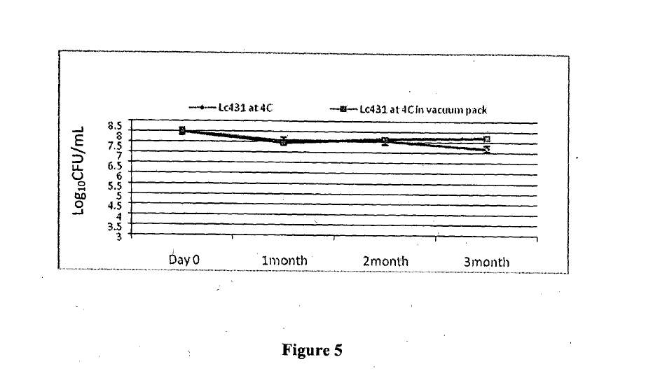

Samples of the supplemented meal replacement protein powder were stored in either a sealed container or vacuum packed in foil. These samples were stored at 4° C. and tested over a three month period to assess probiotic survival. The results of these tests are shown below in Table 7 and FIG. 5.

TABLE 7
Probiotic Viability Test Results.

| | | Cell Viability | Cell Viability | Cell Viability |
|---|---|---|---|---|
| | Cell Viability | after 1 Month | after 2 Months | after 3 Months |
| | after 0 Days of | of Storage at | of Storage at | of Storage at |
| | Storage at 4° C. | 4° C. | 4° C. | 4° C. |
| Sample | (Log₁₀ CFU/mL) | (Log₁₀ CFU/mL) | (Log₁₀ CFU/mL) | (Log₁₀ CFU/mL) |
| Dry blend in | 8.01 | 7.57 | 7.58 | 7.22 |
| container | | | | |
| Dry blend in | 8.01 | 7.47 | 7.67 | 7.73 |
| vacuum foil | | | | |
| pack | | | | |

### Example 10

### Beverages Supplemented by Microparticles—Stability of Encapsulation at Low pH

Microparticles in which 2.5%, by weight, Lactobacillus casei Lc431 (Lc431) was encapsulated within a matrix of sodium alginate and pectin cross-linked using calcium chloride were prepared using the method described in International Application No. PCT/AU2008/001695 (Publication No. WO 2009/062254). These microparticles were then coated with the coating composition of Example 3 by manually mixing together microparticles and the coating composition at a microparticle:coating composition ratio of 10:3 on a weight basis.

### Part 1—Addition to a Juice-Based Beverage

Microparticles were added to juice drink comprising, by weight, 20% apple juice, 5% mango juice and 75% water to produce a supplemented juice drink comprising 1% microparticles on a weight basis. The supplemented juice was pH 16.

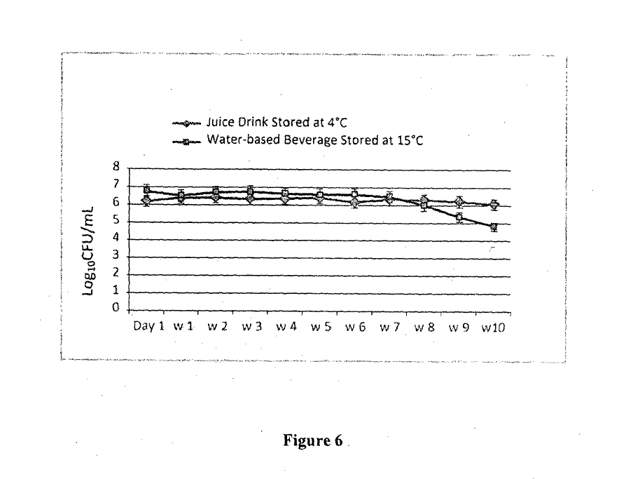

Samples of the supplemented juice drink were stored at 4° C. and tested over a ten week period to assess probiotic survival. The results of these tests are shown below in Table 8 and FIG. 6.

### Part 2—Addition to a Water-Based Beverage

Microparticles were added to water-based beverage to produce a supplemented beverage comprising, on a weight basis: 4% trehalose, 2% Litess II from DuPont™ Danisco®, 2% fructose, 0.2% xanthan gum, 0.05% potassium sorbate, 0.025% ascorbic acid, 1% microparticles. The supplemented beverage was pH 4.5.

Samples of the supplemented, beverage were stored at 15° C. and tested over a ten week period to assess probiotic survival. The results of these tests are shown below in Table 8 and FIG. 6.

TABLE 8
Probiotic Viability Test Results.

Cell Viability
(Log₁₀ CFU/mL)

| | | Samples of |
|---|---|---|
| | Samples of Juice | Water-based |
| Measurement | Drink Stored at | Beverage Stored |
| Date | 4° C. | at 15° C. |
| Day 1 | 6.2 | 6.77 |
| Week 1 | 6.4 | 6.54 |
| Week 2 | 6.43 | 6.73 |
| Week 3 | 6.34 | 6.74 |
| Week 4 | 6.37 | 6.65 |
| Week 5 | 6.40 | 6.60 |
| Week 6 | 6.18 | 6.62 |
| Week 7 | 6.34 | 6.50 |
| Week 8 | 6.30 | 6.01 |
| Week 9 | 6.22 | 5.37 |
| Week 10 | 6.07 | 4.82 |

### Example 11

### Stability of Coated Microparticles at a High Storage Temperature

Microparticles in which 2.5%, by weight, Lactobacillus casei Lc431 (Lc431) was encapsulated within a matrix of sodium alginate and pectin cross-linked using calcium chloride were prepared using the method described in International Application No. PCT/AU2008/001695 (Publication No. WO 2009/062254). These microparticles were then coated with the coating composition of Example 3 by manually mixing together microparticles and the coating composition at a microparticle:coating composition ratio of 10:3 on a weight basis.

The microparticles were combined into the following blends.

Blend 1: microparticles and PromOat™ blended together at a ratio, by weight, of 1:9.

Blend 2: microparticles, Hi-Maize® Resistant Starch and inulin blended together at a ratio, by weight, of 1:5:4.

Blend 3: microparticles, Hi-Maize® Resistant Starch and trehalose blended together at a ratio, by weight, of 1:5:4.

For the purposes of comparison, the following comparative blended were prepared.

Comparative Blend 1: Lactobacillus casei Lc431 concentrate (i.e. un-encapsulated probiotic) and PromOat™ blended together at a ratio, by weight, of 1:399.

Comparative Blend 2: Lactobacillus casei Lc431 concentrate (i.e. un-encapsulated probiotic), Hi-Maize® Resistant Starch and inulin blended together at a ratio, by weight, of 6:1330:1064.

Comparative Blend 3: Lactobacillus casei Lc431 concentrate (i.e. un-encapsulated probiotic), Hi-Maize® Resistant Starch and trehalose blended together at a ratio, by weight, of 6:1330:1064.

Blends 1, 2 and 3 and Comparative Blends 1, 2 and 3 were stored at 37° C. for one week and tested to assess probiotic survival following storage. The results of these tests are shown below in Table 9.

TABLE 9
Probiotic Viability Test Results.

Cell Viability
(Log₁₀ CFU/mL)

| Sample | Day 0 | Week 1 |
|---|---|---|
| Blend 1 | 8.26 | 8.72 |
| Comparative Blend 1 | 9.48 | 5 |
| Blend 2 | 8.09 | 7.67 |
| Comparative Blend 2 | 9.35 | 5 |
| Blend 3 | 8.18 | 7.54 |
| Comparative Blend 3 | 9.00 | 5 |

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Many modifications will be apparent to those skilled in the art without departing from the scope of the present invention.

1. A process for producing a coating composition comprising blending together a lipid, a polyol plasticizer, trehalose, a denatured protein and a carrier.

2. A process according to claim 1, wherein the lipid is blended with the denatured protein and the carrier before the polyol plasticizer and trehalose are blended with the denatured protein.

3. A coating composition produced according to the process of claim 1 or 2.

4. A coating composition comprising a blend of a denatured protein, a lipid, a polyol plasticizer, trehalose, and a carrier.

5. A coating composition according to claim 3 or 4, wherein the denatured protein comprises whey protein isolate.

6. A coating composition according to claim 3, 4 or 5, wherein the denatured protein comprises pea protein.

7. A coating composition according to any one of claims 3 to 6, wherein the lipid is canola oil.

8. A coating composition according to any one of claims 3 to 7, wherein the polyol plasticizer is glycerol.

9. A coating formed from the coating composition of any one of claims 3 to 8.

10. A coated product comprising a microparticle coated with the coating composition according to any one of claims 3 to 8.

11. A coated product according to claim 10, wherein the microparticle comprises an active having a flavour.

12. A method of masking flavours comprising coating an active having a flavour with a coating composition according any one of claims 3 to 8 to mask the flavour.

13. A method of preventing or reducing development of a flavour comprising coating an active capable of developing a flavour upon exposure to a degrading environment with a coating composition according to any one of claims 3 to 8 to prevent or to reduce exposure of the active to the degrading environment.

14. A method of preventing or reducing degradation of an active comprising coating an active with a coating composition according to any one of claims 3 to 8 to prevent or to reduce exposure of the active to a degrading environment.

15. A method of preventing or reducing leakage of an active from a product comprising coating a product containing an active with a coating composition according to any one of claims 3 to 8 to prevent or to reduce leakage of the active from the product.

16. Use of a coating composition according to any one of claims 3 to 8 to mask, or to prevent or to reduce development of, a flavour.

17. Use of a coating composition according to any one of claims 3 to 8 to prevent or to reduce degradation of an active.

18. Use of a coating composition according to any one of claims 3 to 8 to prevent or to reduce leakage of an active from a product containing the active.

19. A method of maintaining probiotic viability or improving probiotic survival in a product containing a probiotic, said method comprising coating the product with a coating composition according to any one of claims 3 to 8.

20. Use of a coating composition according to any one of claims 3 to 8 to maintain viability or to improve survival of a probiotic in a product.
